(19) United States
(12) Patent Application Publication
(10) Pub. No.: US 2013/0136369 A1
(43) Pub. Date: May 30, 2013

(54) METHOD FOR DETECTING BACKGROUND MOTION VECTOR

(71) Applicants: Hsiao-Enmr Chang, Hsinchu City (TW); Tsui-Chin Chen, Hsinchu City (TW); I-Feng Lin, Hsinchu County (TW); Jiande Jiang, Shaanxi Province (CN)

(72) Inventors: Hsiao-Enmr Chang, Hsinchu City (TW); Tsui-Chin Chen, Hsinchu City (TW); I-Feng Lin, Hsinchu County (TW); Jiande Jiang, Shaanxi Province (CN)

(73) Assignee: NOVATEK MICROELECTRONICS CORP., Hsinchu (TW)

(21) Appl. No.: 13/548,174

(22) Filed: Jul. 12, 2012

(30) Foreign Application Priority Data
Nov. 25, 2011 (TW) 100143367

(51) Int. Cl. G06K 9/68

(52) U.S. Cl. 382/218

(57) ABSTRACT

Method for searching for a small moving object is used to insert an inserting image frame between two adjacent image frames. An inserting region in the inserting image frame is selected. Multiple preset extending directions passing through the inserting region are selected. The extending directions respectively intersect the two image frames simultaneously to analyze whether the extending directions satisfy a condition of movement of the same image object, and obtain at least one motion vector (MV) corresponding to the extending direction. A globe MV between the first image frame and the second image frame is obtained. It is compared whether a motion-vector difference between the at least one MV and the globe MV is smaller than a setting value, and then first local-region image data and second local-region image data corresponding to the MV are used for compensation to produce an inserting image for the inserted region about background.

### CROSS-REFERENCE TO RELATED APPLICATION

This application claims the priority benefit of Taiwan application serial no. 100143367, filed on Nov. 25, 2011. The entirety of the above-mentioned patent application is hereby incorporated by reference herein and made a part of this specification.

### BACKGROUND OF THE INVENTION

1. Field of the Invention

The present invention generally relates to a method for detecting a background motion vector (MV) in a dynamic image, so as to prevent influence of a small moving object of foreground.

2. Description of Related Art

Display of a dynamic image usually has a background image and a foreground image. The background image is, for example, an entire image of the environment, and the foreground image is, for example, an image of a small moving object in the environment image. The background image and the foreground image usually may move.

When the dynamic scene is shot by using a video camera, the image is shot with a fixed frame rate, that is, for example, 24 image frames are shot per second. The digital image and a common play speed, for example, a play speed of 60 frames per second, are inconsistent. Therefore, in cooperation with an image playing mode, another frame needs to be inserted between two frames. However, if on an inserting region of the inserting frame, the background image and the foreground image just move to the position, the background image and the foreground image may be used for image compensation. However, if the foreground image is inappropriately used for compensation to the background image, the foreground image may be produced, for example, flicker noises of the small moving object.

It is an element to be considered for improving image quality how to reduce interferences of the small moving object on the background image.

### SUMMARY OF THE INVENTION

Accordingly, the present invention is directed to a method for detecting a background MV, capable of reducing interference noises of a foreground image on a background image.

The present invention provides a method for detecting a background MV, used to insert an inserting image plane between a first image plane and a second image plane. The method includes: selecting an inserting region in the inserting image plane; using a position of the inserting region as a reference region, forming multiple extending directions in multiple local regions in a preset scope and the reference region, the extending directions respectively intersecting the first image plane and the second image plane to obtain multiple pairs of local-region image data, in which each pair of local-region image data includes first local-region image data of the first image plane and second local-region image data of the second image plane; calculating a difference value between the first local-region image data and the second local-region image data of each pair of local-region image data, in which when the difference value is smaller than a setting value, the corresponding extending direction is considered as at least one initial stage MV; obtaining a globe MV between the first image plane and the second image plane; and comparing whether a motion-vector difference between the at least one MV and the globe MV is smaller than a setting value, in which if the motion-vector difference is smaller than the setting value, the first local-region image data and the second local-region image data corresponding to the MV are used for compensation to produce an inserting image of the inserting region belonging to background.

The present invention also provides a method for detecting a background MV, used to insert an inserting image frame between a first image frame and a second image frame being adjacent in a dynamic image display data. The method includes: selecting an inserting region in the inserting image frame; selecting multiple preset extending directions passing through the inserting region; the extending directions respectively intersecting the first image frame and the second image frame at the same time to obtain first local-region image data and second local-region image data, analyzing whether the extending directions satisfy a condition of movement of the same image object, and obtaining at least one MV corresponding to the extending direction; obtaining a globe M between the first image frame and the second image frame; and comparing whether a motion-vector difference between the at least one MV and the globe MV is smaller than a setting value, in which if the motion-vector difference is smaller than the setting value, the corresponding first local-region image data and the corresponding second local-region image data are used for compensation to produce an inserting image of the inserting region belonging to background.

According to an embodiment of the present invention, the method for detecting the background MV according to the present invention further includes a confirming step to confirm that the first local-region image data and the second local-region image data corresponding to the MV are belonging to a background image. The confirming step includes: searching for a first MV from the second image plane with the first local-region image data of the first image plane; checking whether the first MV and the MV are inconsistent; and if the first MV and the MV are inconsistent, only using the second local-region image data for compensation, so as to produce the inserting image of the inserting region.

According to an embodiment of the present invention, in the method for detecting the background MV according to the present invention, the confirming step further includes: if the first MV and the MV are consistent, searching for a second MV from the first image plane with the second local-region image data of the second image plane; checking whether the second MV and the MV are inconsistent; and if the second MV and the MV are inconsistent, only using the first local-region image data for compensation, so as to produce the inserting image of the inserting region.

According to an embodiment of the present invention, the method for detecting the background MV according to the present invention further includes a confirming step. The confirming step includes: checking whether one of the first local-region image data and the second local-region image data corresponding to the MV is belonging to foreground data; and if one of the first local-region image data and the second local-region image data is belonging to the foreground data, only using the other one of the first local-region image data and the second local-region image data for compensation to produce the inserting region.

In order to make the aforementioned features and advantages of the disclosure comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a problem solved for two image frames according to the present invention.

FIG. 2 is a schematic view of motion variance of a foreground image and a background image on a time axis corresponding to FIG. 1.

FIG. 3 is a schematic view of an inserting mechanism for a background image when an image frame is inserted according to an embodiment of the present invention.

FIG. 4 is a schematic view of a mechanism in which multiple pairs of searched local-region images may produce errors according to an embodiment of the present invention.

FIG. 5 is a schematic view of a confirming step of judging that an image is belonging to a foreground image according to an embodiment of the present invention.

FIG. 6 is a schematic view of a confirming step of judging that an image is belonging to a foreground image according to an embodiment of the present invention.

FIG. 7 is a schematic flow chart of a method for detecting a background MV according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

For a shot digital dynamic image, a previous image frame and a next image frame may have different contents, and a moving object may exist.

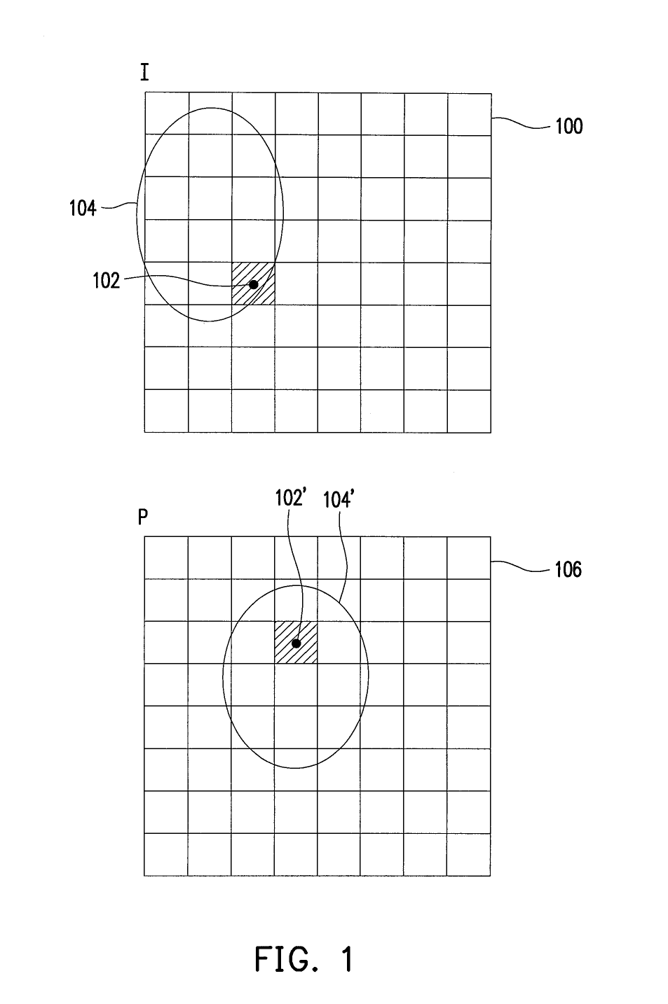

FIG. 1 is a schematic view of a problem solved for two image frames according to the present invention. Referring to FIG. 1, an image frame 100, also called frame I, is shot image data, and display of the image frame 100 relative to a time point is an image picture. The image picture is a pixel array formed by multiple pixels, and the pixel array may be, for example, cut into blocks for being analyzed. Alternatively, the situation depends on actual arrangement.

A current image frame 106, also called frame P, is current image data closely next to the previous image frame 100, and is also an image picture. The content of the image frame 100 may be usually divided into a background image 104 and a foreground image 102. The foreground image 102 may be a small moving object. The background image 104 is an image of environment scene. Generally, the background image 104 occupies most part of the image, and may possibly move. The foreground image 102 is the small moving object, and a moving direction is different from a moving direction of the background image 104. For the image frame 106, because of moving, a foreground image 102′ may move, and a background image 104′ may also move. Definitely, the background image 104′ may be static.

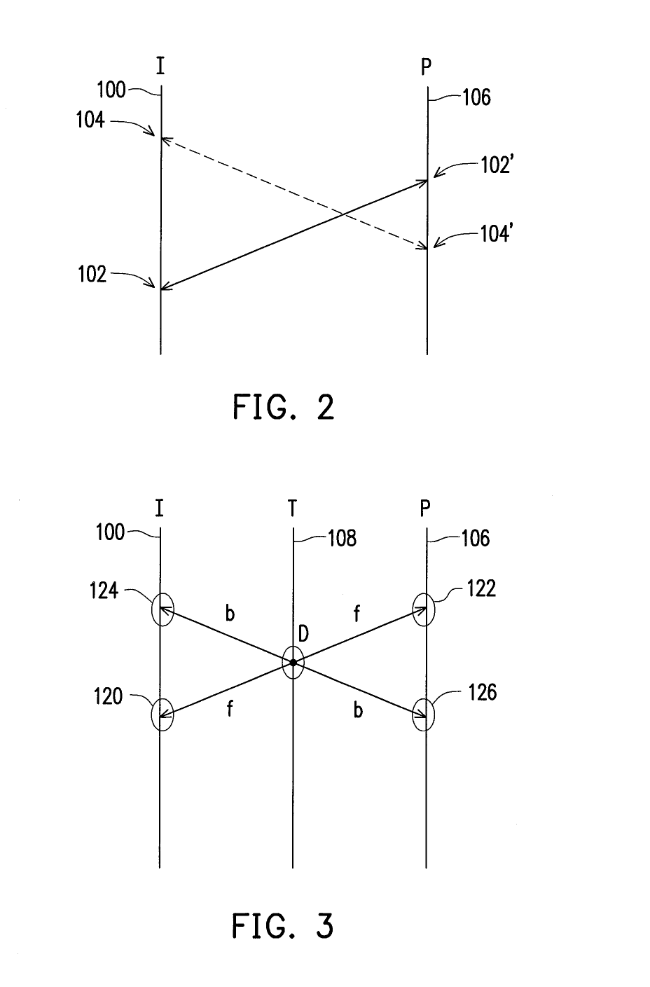

FIG. 2 is a schematic view of motion variance of a foreground image and a background image on a time axis corresponding to FIG. 1. Referring to FIG. 2, the image frame 100 may have the background image 104 and the foreground image 102. If the background image 104 and the foreground image 102 are moving, usually they usually move to different directions. Therefore, after a time interval of 1 hour, for the shot image frame 106, the foreground image 102 moves to the foreground image 102′, and the background image 104 moves to the foreground image 104′. The variance degree of the moving is represented by an MV, which represents that a motion amount and a direction of the same object from the image frame 100 to the image frame 106. The MV is a usually used parameter known by those skilled in the art, and details are not further described.

FIG. 3 is a schematic view of an inserting mechanism for a background image when an image frame is inserted according to an embodiment of the present invention. Referring to FIG. 3, usually actually shot frame rate is smaller than a played frame rate, for example, another image frame 108, also called a frame T, needs to be inserted between two actually shot adjacent image frames 100 and 106, for example, the inserting frame T is inserted at an intermediate time point.

For image recognition, it is determined whether the image frame 100 and the image frame 106 have the same image content by adopting a usually known sum of absolute difference (SAD), which is a sum of absolute difference of all pixel values between an image block of the image frame 100 and an image block of the same shape of the image frame 106.

For a desired state, if the detected image blocks have the same content, the situation is satisfied, so that the SAD value is close to 0. In other words, if the SAD value is smaller than a degree, it represents that the image frame 100 and the image block detected on the image frame 106 may be considered to be the same object, so as to calculate the MV.

An inserting region 110, marked by D, to be inserted in the image frame 108, needs to be inserted through data of the image frame 100 and the image frame 106, so that the same corresponding local-region images need to be found. Corresponding to the position of the inserting region 110, the image passing through the inserting region 110 from the image frame 100 to the image frame 106 includes the image belonging to the background image 104 and the image belonging to the foreground image 102, which is, for example, the image of the small moving object.

In FIG. 2, the SAD values of the local-region images belonging to the foreground image 102 and the background image 104 are smaller than that a setting value to be selected, but have different MVs.

Under a desired state, for the object belonging to the foreground image searched through the inserting region 110, marked by f, a domain image 120 of the image frame 100 and a domain image 122 of the image frame 106 are used for corresponding, so as to become a pair of local-region images. Similarly, for the object belonging to the background image searched through the inserting region D, marked by b, a domain image 124 of the image frame 100 and a domain image 126 of the image frame 106 are used for corresponding, so as to become another pair of local-region images. The two pairs of local-region images have different MVs.

In addition, a globe MV exists from the image frame 100 to the image frame 106, so as to decide the entire moving situation. The proportion of the foreground image is relatively small, so that the MV of the background image and the globe MV are consistent. The globe MV may be used to differentiate the foreground image and the background image.

However, for the pair of local-region images 124 and 126 belonging to the background image, one local-region image may be from the foreground image. Therefore, further confirm is needed.

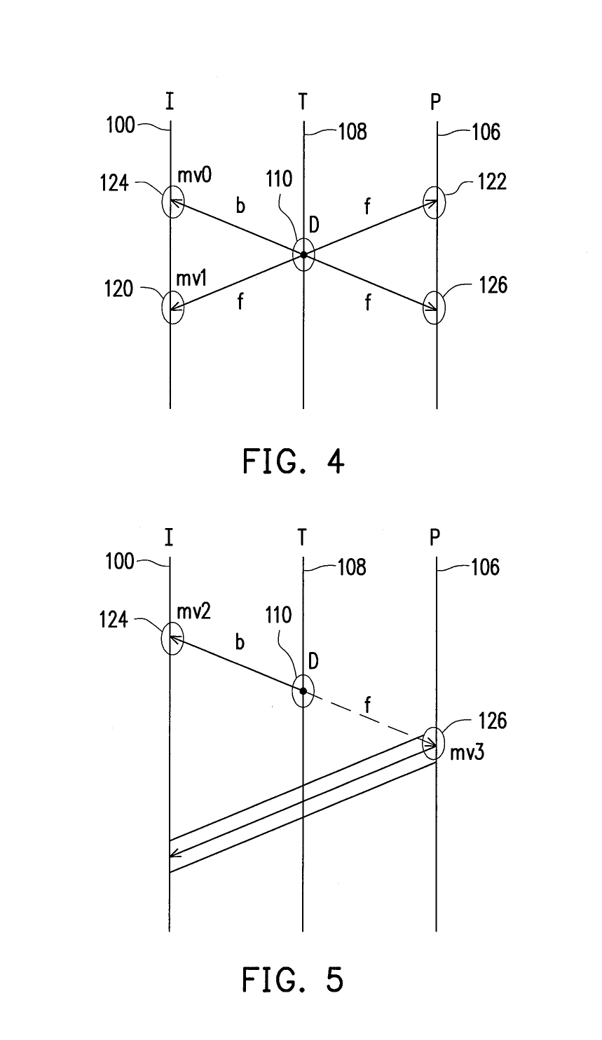

FIG. 4 is a schematic view of a mechanism in which multiple pairs of searched local-region images may produce errors according to an embodiment of the present invention. Referring to FIG. 4, if a moving path of the foreground image may pass through the inserting region 110, and intersect a moving path of the background image at the inserting region 110, as the small moving object is easily detected, the MV mv1 is accurately calculated. For another pair of local-region images 124 and 126, as the globe motion-vector difference satisfies the consistent condition, the images are considered to be images belonging to the background, and the MV mv0 is calculated. However, for the actual content, one of the two local-region images 124 and 126 may be belonging to the foreground image.

For example, the local-region image 124 in the image frame 100 is surely belonging to the background image, and the local-region image 126 in the image frame 106 may be belonging to the foreground data. If the inserting image data is to be inserted to the inserting region 110, the data of the local-region image 126 is used for compensation, the image of the inserting region 110 may include the data of the foreground image, so as to result in the interference of the foreground image.

In order to confirm whether the local-region image 124 or the local-region image 126 includes the data of the foreground image, the MV is searched for and calculated from the image frame 100 or the image frame 106 respectively. Then, judging is made through analysis of the MV.

FIG. 5 is a schematic view of a confirming step of judging that an image is belonging to a foreground image according to an embodiment of the present invention. Referring to FIG. 5, the MV mv2 obtained according to the method is corresponding to the local-region image 124 and the local-region image 126. Next, it is validated that the local-region image 124 and the local-region image 126 are belonging to the background image.

Therefore, one of the local-region image 124 and the local-region image 126 is taken for confirmation, for example, the local-region image 126 of the image frame 106 is taken for confirmation.

If the local-region image 126 is from the foreground image, the MV mv3 obtained after being searched for from the image frame 100 with the local-region image 12 is different from the previously obtained MV mv2 or the globe MV. Therefore, the mechanism may further determine whether the local-region image 126 is belonging to the foreground image. If the local-region image 126 is belonging to the foreground image, the image content of the inserting region D is obtained according to the compensation of the local-region image 124 of the image frame 100.

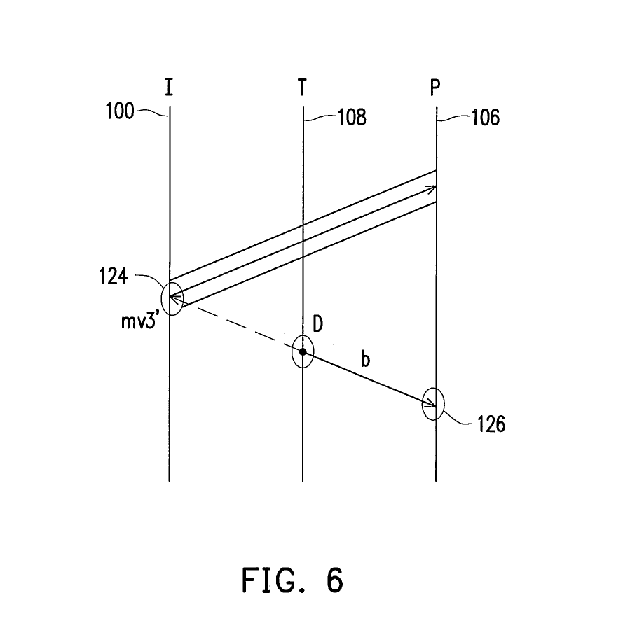

If it is judged that the MV obtained after being searched for from the image frame 100 with the local-region image 126 is belonging to the background image, the local-region image 124 may be further checked. FIG. 6 is a schematic view of a confirming step of judging that an image is belonging to a foreground image according to an embodiment of the present invention. Referring to FIG. 6, the local-region image 124 of the image frame 100 may obtain the MV mv3 from the local-region image 126. If the local-region image 124 is belonging to the foreground image, the obtained MV mv3′ is different from the MV mv2 or the globe MV.

Definitely, the sequence of FIG. 5 and FIG. 6 may be reverse, that is, the local-region image 124 of the image frame 100 is taken for confirmation. Then, if necessary, the local-region image 126 is confirmed. Alternatively, both the local-region image 124 and the local-region image 126 are taken for confirmation.

According to the above manner, when the background image is inserted, the MV belonging to the background image is judged, and then if necessary, confirmation is performed, so as to prevent the interference of the foreground image.

An image frame 108 to be inserted has multiple inserting regions D requiring the inserting image, so as to insert the complete image frame 108. Therefore, according to the planed size, the inserting region D may move in the image frame 108, so as to complete the entire image insertion calculation.

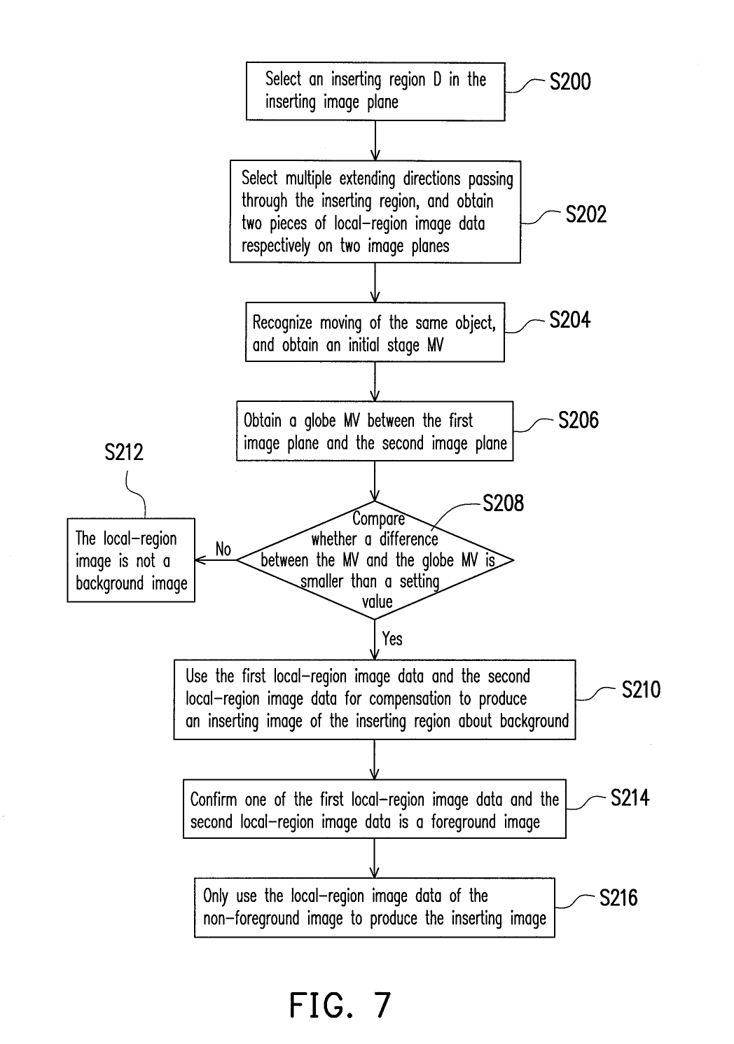

From the above mechanism, the present invention may be represented by an operation flow. FIG. 7 is a schematic flow chart of a method for detecting a background MV according to an embodiment of the present invention.

Referring to FIG. 7, a method for searching for a small moving object may be used to insert an inserting image plane between a first image plane and a second image plane. In Step S200, an inserting region D in the inserting image plane is selected. In Step S202, a position of the inserting region D is used as a reference region, multiple extending directions are formed in multiple local regions in a preset scope and the reference region, and the extending directions respectively intersect the first image plane and the second image plane to obtain multiple pairs of local-region image data. Each pair of local-region image data includes first local-region image data of the first image plane and second local-region image data of the second image plane.

In Step S204, a difference value between the first local-region image data and the second local-region image data of each pair of local-region image data is calculated, in which when the difference value is smaller than a setting value, the corresponding extending direction is considered as at least one initial stage MV. In Step S206, a globe MV between the first image plane and the second image plane is obtained. In Step S208, it is compared whether a motion-vector difference between the at least one MV and the globe MV is smaller than a setting value. In Step S210, if the motion-vector difference is smaller than the setting value, the first local-region image data and the second local-region image data corresponding to the MV are used for compensation to produce an inserting image of the inserting region belonging to background. In Step 212, if the motion-vector difference is greater than the setting value, the local-region image is not a background image.

Step 214 is a further confirming step, in which one of the first local-region image data and the second local-region image data is confirmed to be a foreground image. In Step 216, only the local-region image data of the non-foreground image is used to produce the inserting image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detecting a background motion vector (MV), used to insert an inserting image plane between a first image plane and a second image plane, comprising:
selecting an inserting region in the inserting image plane;
using a position of the inserting region as a reference region, forming multiple extending directions in multiple local regions in a preset scope and the reference region, the extending directions respectively intersecting the first image plane and the second image plane to obtain multiple pairs of local-region image data, wherein each pair of local-region image data comprises first local-region image data of the first image plane and second local-region image data of the second image plane;
calculating a difference value between the first local-region image data and the second local-region image data of each pair of local-region image data, wherein when the difference value is smaller than a setting value, the corresponding extending direction is considered as at least one initial stage MV;
obtaining a globe MV between the first image plane and the second image plane; and
comparing whether a motion-vector difference between the at least one MV and the globe MV is smaller than a setting value, wherein if the motion-vector difference is smaller than the setting value, the first local-region image data and the second local-region image data corresponding to the MV are used for compensation to produce an inserting image of the inserting region belonging to backgound.

2. The method for detecting a background MV according to claim 1, further comprising a confirming step to confirm that the first local-region image data and the second local-region image data corresponding to the MV are belonging to a background image, wherein the confirming step comprises:
searching for a first MV from the second image plane with the first local-region image data of the first image plane;
checking whether the first MV and the MV are inconsistent; and
if the first MV and the MV are inconsistent, only using the second local-region image data for compensation, so as to produce the inserting image of the inserting region.

3. The method for detecting a background MV according to claim 2, wherein the confirming step further comprises:
if the first MV and the MV are consistent, searching for a second MV from the first image plane with the second local-region image data of the second image plane;
checking whether the second MV and the MV are inconsistent; and
if the second MV and the MV are inconsistent, only using the first local-region image data for compensation, so as to produce the inserting image of the inserting region.

4. The method for detecting a background MV according to claim 1, further comprising a confirming step, wherein the confirming step comprises:
checking whether one of the first local-region image data and the second local-region image data corresponding to the MV is belonging to foreground data; and
if one of the first local-region image data and the second local-region image data is belonging to the foreground data, only using the other one of the first local-region image data and the second local-region image data for compensation to produce the inserting region.

5. The method for detecting a background MV according to claim 1, wherein the difference value between the first local-region image data and the second local-region image data is a pixel sum of absolute difference (SAD).

6. The method for detecting a background MV according to claim 1, wherein the inserting region comprises multiple pixels.

7. The method for detecting a background MV according to claim 1, wherein the first image plane and the second image plane are two adjacent frames of a dynamic image, and the inserting image plane is an inserting frame to be inserted between the two frames.

8. The method for detecting a background MV according to claim 1, wherein the inserting region moves in an entire region of the inserting image plane to complete image insertion of the entire region.

9. The method for detecting a background MV according to claim 1, wherein the inserting image of the inserting region performs image insertion according to a value of the MV.

10. A method for detecting a background motion vector (MV), used to insert an inserting image frame between a first image frame and a second image frame being adjacent in a dynamic image display data, comprising:
selecting an inserting region in the inserting image frame;
selecting multiple preset extending directions passing through the inserting region;
the extending directions respectively intersecting the first image frame and the second image frame at the same time to obtain first local-region image data and second local-region image data, analyzing whether the extending directions satisfy a condition of movement of the same image object, and obtaining at least one MV corresponding to the extending direction;
obtaining a globe M between the first image frame and the second image frame; and
comparing whether a motion-vector difference between the at least one MV and the globe MV is smaller than a setting value, wherein if the motion-vector difference is smaller than the setting value, the corresponding first local-region image data and the corresponding second local-region image data are used for compensation to produce an inserting image of the inserting region belonging to background.

11. The method for detecting a background MV according to claim 10, further comprising a confirming step to confirm that the first local-region image data and the second local-region image data corresponding to the MV are belonging to a background image, wherein the confirming step comprises:
searching for a first MV from the second image plane with the first local-region image data of the first image plane;
checking whether the first MV and the MV are inconsistent; and
if the first MV and the MV are inconsistent, only using the second local-region image data for compensation, so as to produce the inserting image of the inserting region.

12. The method for detecting a background MV according to claim 11, wherein the confirming step further comprises:
if the first MV and the MV are consistent, searching for a second MV from the first image plane with the second local-region image data of the second image plane;
checking whether the second MV and the MV are inconsistent; and
if the second MV and the MV are inconsistent, only using the first local-region image data for compensation, so as to produce the inserting image of the inserting region.

13. The method for detecting a background MV according to claim 10, further comprising a confirming step, wherein the confirming step comprises:
checking whether one of the first local-region image data and the second local-region image data corresponding to the MV is belonging to foreground data; and
if one of the first local-region image data and the second local-region image data is belonging to the foreground data, only using another one of the first local-region image data and the second local-region image data for compensation to produce the inserting region.
